(19) United States
(12) Patent Application Publication
(10) Pub. No.: US 2007/0275283 A1
(43) Pub. Date: Nov. 29, 2007

(54) SLIM-TYPE FUEL CELL DEVICE

(76) Inventors: Tsang-Ming Chang, Taipei (TW); Ko-Chen Shen, Taipei (TW); Chien-An Chen, Taipei (TW); Wen-Jui Chuang, Banciao (TW)

Correspondence Address: G. LINK CO., LTD., 3550 BELL ROAD, MINOOKA, IL, 60447, US

(21) Appl. No.: 11/751,649

(22) Filed: May 22, 2007

(30) Foreign Application Priority Data
May 24, 2006 (TW) 095118371

(51) Int. Cl. H01M 8/04

(52) U.S. Cl. 429/26; 429/34

(57) ABSTRACT

The present invention discloses a slim type fuel cell device; wherein, the shell is provided with at least one first internal space and one second internal space, and, the shell portion forming the first internal space is compatible to the profile of the slim-type optical storage drive; the fuel cell stack, which is configured at the front end of the first internal space, and provided with at least one sheet of fuel cell module, in which these fuel cell modules are stacked together. The wind cover is configured in the first inner space, and one end of the wind cover is airtight joined on one side of these fuel cell modules, and the other end is airtight joined with the inlet of the wind box. The wind box is configured in the second inner space, and provided with an inlet and an outlet. A partial structure of the condensing device is configured in the first inner space, and the other partial structure is configured in the second inner space. One end of the condensing device is connected with the outlet of the wind box, and the other end is connected with the mixing tanks with pipes. The mixing tank is configured in the second inner space, and connected with the anode fuel inlet of the fuel cell stack with pipes.

### FIELD OF THE INVENTION

The present invention relates to a fuel cell device, and particularly to a slim type fuel cell device compatible with the profile of a slim type optical storage drive

### BACKGROUND OF THE INVENTION

The connection between a conventional fuel cell device and a power consumption apparatus is usually implemented with two methods. The first method is that the internal space of the power consumption apparatus itself is previously designed as a dedicated space for accommodating the conventional fuel cell device. This kind of connection method could actually combine the conventional fuel cell device with the portable electronic machine together as a whole in the space, but the conventional fuel cell device could only be suitable for and accommodated in the specific power consumption apparatus, and the power consumption apparatus is also limited for using such kind of conventional fuel cell device. The second method is that the power consumption apparatus employed a power cable, and connected to the conventional fuel cell device with this external power cable. This kind of connection is rather easy, but, for the portable electronic machine, such as notebook computer, the conventional fuel cell device could not be combined with the portable electronic machine together as a whole in the space, and caused much inconvenience for the user.

The profile structure of the conventional fuel cell device has not formed a standard, and the manufacturers for the fuel cell device currently still could design the profile freely by themselves, so that the conventional fuel cell device still could not be combined with the existed portable electronic machine together as a whole in the space.

The inventor of the present invention has been in view of the conventional defects, and worked for the improvement to disclose a slim type fuel cell device compatible with the profile of the slim type optical storage drive, so that the existed portable electronic machine and the slim type fuel cell device could be combined together as a whole in the space.

### SUMMARY OF THE INVENTION

The main object of the present invention is to provide a slim type fuel cell, which could easily be combined with the existed portable electronic machine together as a whole in the space.

To this end, the present invention provides a slim type fuel cell device, which comprises: a shell, which is provided with at least a first internal space and a second internal space, in which the first internal space and the second internal space are tightly adjoined, and the shell portion forming the first space is compatible with the profile of the slim type optical storage drive; a fuel cell stack, which is configured at the front end of the first internal space, and provided with at least one fuel cell module, in which these fuel cell modules are stacked together; a wind cover, which is configured in the first space, in which one end of the wind cover is airtight joined on one side of these fuel cell modules, and the other end is airtight joined at the inlet of the wind box; a wind box, which is configured in the second internal space, and provided with an inlet and an outlet; a condensing device, in which a partial structure of the condensing device is configured in the first internal space, and another partial structure of the condensing device is configured in the second internal space, and one end of the condensing device is connected with t the outlet of the wind box, and the other end is connected with the mixing tank with pipes; and, a mixing tank, which is configured in the second internal space, and connected to the anode fuel inlet of the fuel cell stack with pipes.

### BRIEF DESCRIPTION OF DRAWINGS

The present invention would be detailed described in the following to make the skilled in the art understand the object, features and effects of the present invention through the following embodiments and the attached figures, wherein:

FIG. 1 is an operation status diagram for the slim type fuel cell device according to the present invention plugged with an electronic device;

FIG. 2A is a three-dimensional appearance view of the slim type fuel cell device according to the present invention;

FIG. 2B is an internal space diagram of the slim type fuel cell device according to the present invention;

FIG. 2C is an internal structural diagram of the slim type fuel cell device according to the present invention; and

FIG. 3 is an internal piping layout diagram of the slim type fuel cell device according to the present invention.

### DETAILED DESCRIPTION OF THE INVENTION

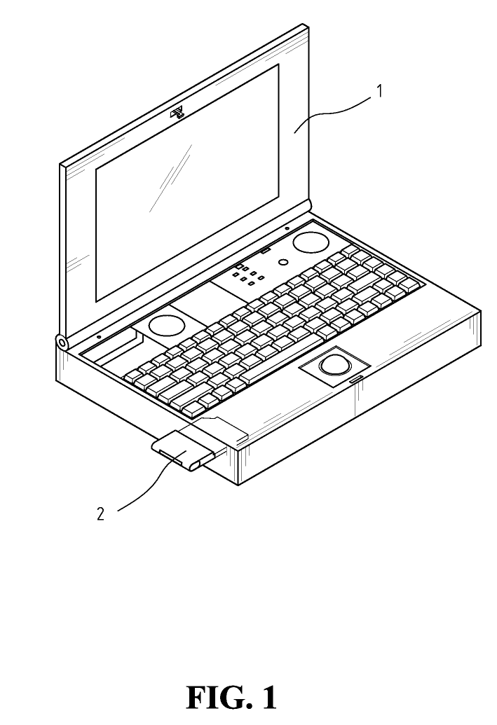

FIG. 1 is an operation status diagram of the slim type fuel cell device according to the present invention plugged with an electronic device. As shown in FIG. 1, the electronic device 1 could be a notebook computer, or any kind of portable electronic machines. The slim type fuel cell device 2 according to the present invention has an overall profile partially compatible with the conventional slim type optical storage drive, such as slim CD-ROM drive, slim DVD drive, slim combo-type drive, slim CD/DVD writer, etc., so that it could employ the space of the electronic device 1 originally occupied by the slim type optical storage drive. The manufacturer of the computer system could design that after retraction of the slim type optical storage drive from the electronic device 1, it could be plugged and connected to the slim type fuel cell device 2. Thus, the electronic device 1 could immediately employ the electric power generated by the slim type fuel cell device 2. This should be one of the important features for the present invention.

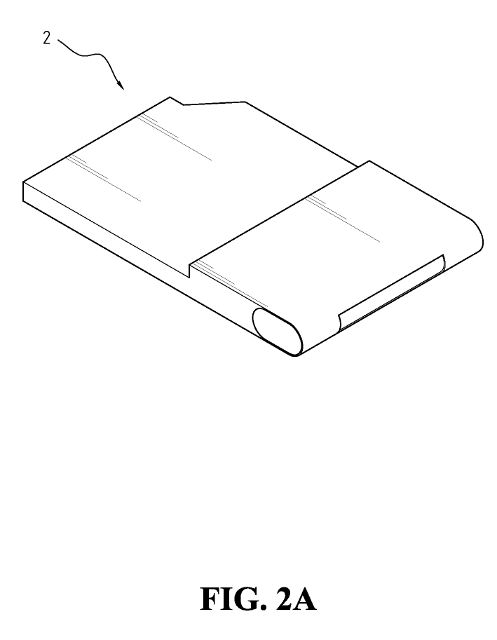

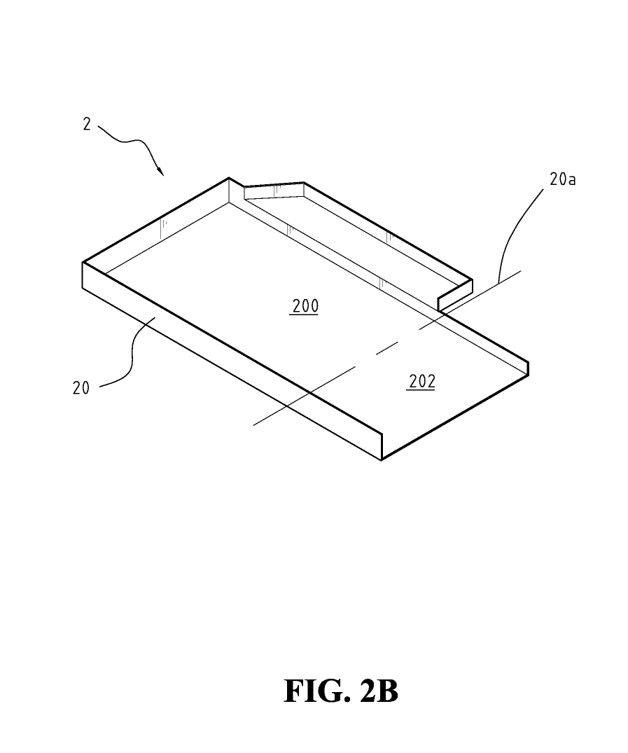

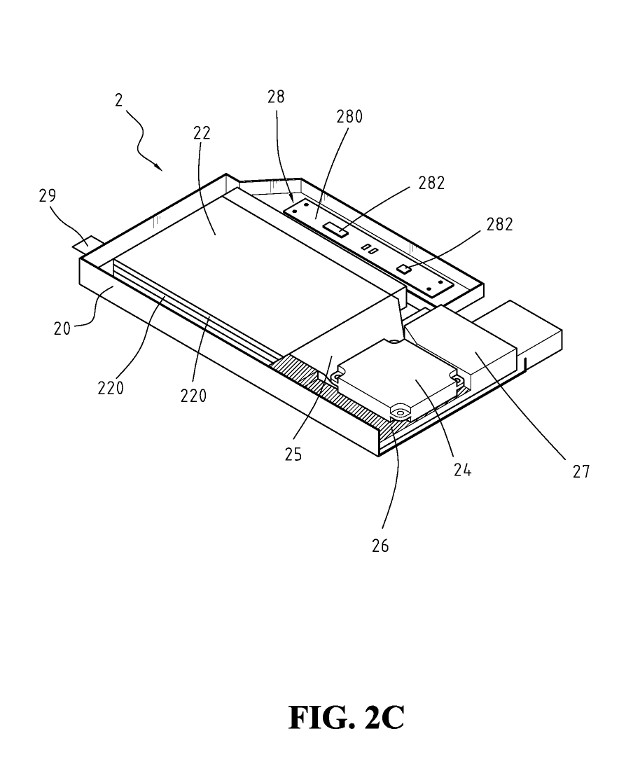

FIG. 2A is a three-dimensional appearance view of the slim type fuel cell device according to the present invention. FIG. 2B is an internal space diagram of the slim type fuel cell device according to the present invention. FIG. 2C is an internal structural diagram of the slim type fuel cell device according to the present invention. The slim type fuel cell device 2 according to the present invention at least comprises: a shell 20, a fuel cell stack 22, a wind box 24, a wind cover 25, a condensing device 26, and a mixing tank 27, which are described in details as follows.

The shell 20 is provided with at least a first internal space 200, and a second internal space 202, wherein the first internal space 200 and the second internal space 202 are separated by a virtual separation line 20a, and the internal spaces 200, 202 are tightly adjoined. The portion of the shell 20 forming the first space 200 is compatible with the profile of a slim type optical storage drive, so that it could employ the space of the electronic device 1 originally designed for the slim type optical storage drive, and could plug the slim type fuel cell device 2 within the space.

The fuel cell stack 22 is configured at the front end of the first internal space 200, and provided with at least one sheet of fuel cell module 220, in which these fuel cell modules 220 are stacked together. The fuel cell module 220 employed by the present invention could be a conventional fuel cell module, but preferably employing the conventional fuel cell module manufactured with the printed circuit process. Each sheet of fuel cell module 220 is stacked in sequence with a cathode flow field board, a bipolar fuel cell board, and an anode flow field board in layers. The bipolar fuel cell board is stacked in sequence with a cathode current collection board, a layer of membrane electrode assembly layer, and an anode current collection board in layers.

The wind box 24 is configured in the second internal space 202, and provided with an inlet and an outlet. Inside the wind box 24, it is configured with a fan, a blower, or a motor driving the fan blades.

The wind cover 25 is configured in the first internal space 200; wherein, one end of the wind cover 25 is airtight joined on one side of these fuel cell modules 220, and the other end is airtight joined at the inlet of the wind box 24.

A partial structure of the condensing device 26 is configured in the first internal space 200, and the other partial structure of the condensing device 26 is configured in the second internal space 202. One end of the condensing device 26 is connected with the outlet of the wind box 24, and the other end is connected with the mixing tank 27 with pipes. The function of the condensing device 26 is used to recycle and collect water, and the recycled water is sent to the mixing tank 27.

The mixing tank 27 is configured in the second internal space 202, and connected to the anode fuel inlet of these fuel cell modules 220. For example, if the fuel cell modules 220 employ the direct methanol fuel cell (DMFC), the mixing tank 27 is used to store the methanol aqueous solution.

Furthermore, as shown in FIG. 2C, the slim type fuel cell device 2 according to the present invention further comprises: a control unit 28 and a connection interface 29; wherein, the control unit 28 is configured on one side of the first internal space 200, which comprises a control circuit board 280, and at least one circuit device 282; wherein, these circuit devices 282 are configured on the control circuit board 280; and, these circuit devices 282 are electrically connected with the fuel cell module 220. In the present invention, these circuit devices 282 could be used to establish a power management circuit, so that the electric power generated by the fuel cell module 220 could be suitable for the electric power required by the electronic device 1; and, the connection interface 29 is at least used for the output of the electricity generated by the fuel cell stack 22, and used to connect with the electronic device 1. In an embodiment of the present invention, the connection interface 29 could be implemented with an electric connector, or electric cable, or a printed circuit board with golden fingers.

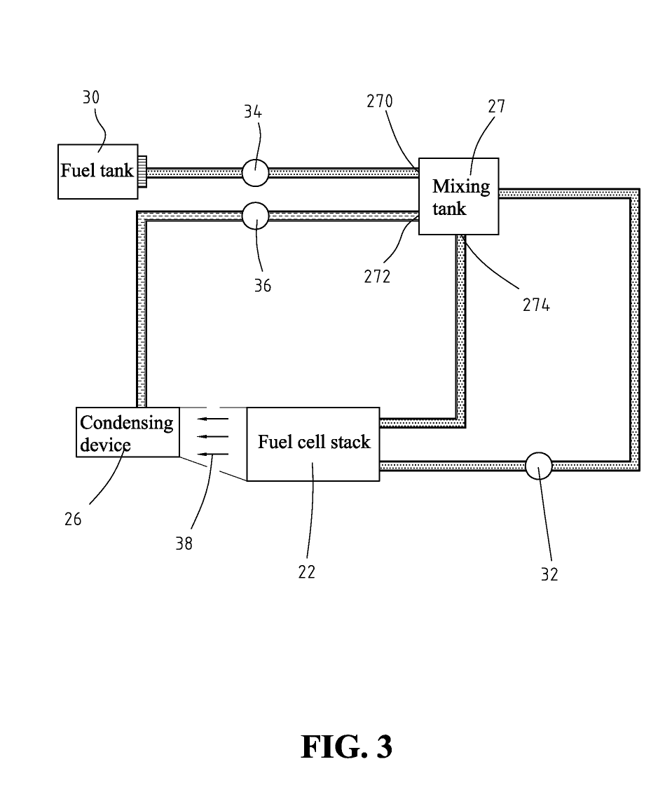

FIG. 3 is an internal pipe layout diagram of the slim type fuel cell device according to the present invention. As shown in FIG. 3, the slim type fuel cell device 2 according to the present invention further comprises: a first pump 32, a second pump 34, and a third pump 36; wherein, the first pump 32 is connected between the mixing tank 27 and the fuel cell stack 22 with pipes, and the first pump 32 is used for pumping the anode fuel in the mixing tank 27 into the anode fuel inlet of these fuel cell modules 220.

The second pump 34 is connected between the mixing tank 27 and the external fuel tank 30 with pipes, and the second pump 34 is used for pumping the fuel in the fuel tank 30 into the first inlet 270 of the mixing tank 27. The fuel tank 30 is usually stored with high density anode fuel. For example, as for the direct methanol fuel cell (DMFC) stack, the fuel tank 30 is used to store the pure methanol.

The third pump 36 is connected between the mixing tank 27 and the condensing device 26 with pipes. The third pump 36 is used to recycle and collect the condensing water from the condensing device 26 into the second inlet 272 of the mixing tank 27. The condensing water recycled and collected from the condensing device 26 is from the vapor 38 generated by the fuel cell stack 22, and condensed by cooling and heat dissipation through the condensing device 26.

Moreover, the anode fuel outlet of the fuel cell module 220 in the slim type fuel cell device 2 according to the present invention could also be connected with the third inlet 274 of the mixing tank 27 with pipes, so that the remaining anode fuel from the fuel cell stack 22 is recycled to the mixing tank 27.

The electronic device 1 equipped with the slim type optical storage drive could all be used in association of the slim type fuel cell device 2 according to the present invention, which is one of the advantages of the present invention. The user could only retract the slim type optical storage drive from the electronic device 1, and replace with the slim type fuel cell device 2, so that the user could operate the electronic device 1 for longer time, and provide with the advantage of portability.

The present invention have been described in details with the preferred embodiments as above, and these disclosed embodiments are not used to limit the scope of the present invention. The skilled in the art could have some changes and modification without departing from the spirit and scope of the present invention, and these changes and modification are still belonged to the attached claims of the present invention.

What is claimed is:

1. A slim type fuel cell device, which comprises:
a shell, which is provided with a first internal space and a second internal space, in which the first internal space and the second internal space are tightly adjoined, and the shell portion forming the first space is compatible with the profile of the slim type optical storage drive;
a fuel cell stack, which is configured at the front end of the first internal space;
a wind cover, which is configured in the first internal space, in which one end of the wind cover is airtight joined on one side of these fuel cell stacks, and the other end is airtight joined at the inlet of a wind box;
the wind box, which is configured in the second internal space, and provided with an inlet and an outlet;
a condensing device, in which a partial structure of the condensing device is configured in the first internal space, and the other partial structure of the condensing device is configured in the second internal space, and one end of the condensing device is connected to the outlet of the wind box, and the other end is connected with the mixing tank with pipes; and,
a mixing tank, which is configured in the second internal space, and connected to the anode fuel inlet of the fuel cell stack with pipes.

2. The slim type fuel cell device according to claim 1, further comprises: a control unit, which is configured on one side of the first internal space, and includes one control circuit board and at least one circuit device, in which these circuit devices are configured on the control circuit board, and these circuit devices are electrically connected to the fuel cell stack.

3. The slim type fuel cell device according to claim 1, further comprises: a connection interface, which is used at least as the output for power generated from the fuel cell stack.

4. The slim type fuel cell device according to claim 3, wherein the connection interface is one of an electric connector, an electric cable and a printed circuit board with golden fingers.

5. The slim type fuel cell device according to claim 1, further comprises: a first pump, which is connected between the mixing tank and the fuel cell stack with pipes, and used for pumping the anode fuel in the mixing tank into the anode fuel inlet of the fuel cell stack.

6. The slim type fuel cell device according to claim 5, further comprises: a second pump, which is connected between the mixing tank and an external fuel tank with pipes, and used for pumping the anode fuel in the fuel tank into a first inlet of the mixing tank.

7. The slim type fuel cell device according to claim 6, further comprises: a third pump, which is connected between the mixing tank and the condensing device with pipes, and used for pumping the condensing water recycled and collected by the condensing device into a second inlet of the mixing tank.

8. The slim type fuel cell device according to claim 1, wherein the anode fuel outlet of the fuel cell stack is connected with the third inlet of the mixing tank with pipes.

9. The slim type fuel cell device according to claim 2, wherein these circuit devices are used to establish a power management circuit.

10. The slim type fuel cell device according to claim 3, wherein the electric device is one of a notebook computer, and a portable electronic machine.

11. The slim type fuel cell device according to claim 1, wherein the mixing tank is used to store the methanol aqueous solution.

12. The slim type fuel cell device according to claim 6, wherein the fuel tank is used to store the pure methanol.
